(19) United States
(12) Patent Application Publication
(10) Pub. No.: US 2025/0039204 A1
(43) Pub. Date: Jan. 30, 2025

(54) Network alert enrichment

(71) Applicant: PALO ALTO NETWORKS (ISRAEL ANALYTICS) LTD., Tel Aviv (IL)

(72) Inventors: Erez Levy, Ganey Tikva (IL); Yarom Dadon, Rishon Le-Zion (IL); Yuval Yarom, Tel Aviv Yafo (IL); Tomer Niv, Carmit (IL); Tom Redlus, Tel Aviv (IL); Jonathan Shai Isakov, Givatayim (IL)

(21) Appl. No.: 18/361,850

(22) Filed: Jul. 30, 2023

(51) Int. Cl. H04L 9/40

(52) U.S. Cl. CPC H04L 63/1425; H04L 63/0236; H04L 63/1416

(57) ABSTRACT

A method, including collecting, during a time period from multiple computers, reports of events, each of the events including communication activity performed by a process having a respective ID and executing on one of the computers. Respective sets of features including characteristics of the activity are generated from the reports, and a model is trained for identifying, based on the features of one or more of the events, the ID of one of the processes performing the one or more of the events. An alert indicating malicious activity and referencing one or more reports of additional communication events performed by a given computer is received from a network management device, and the model is applied to the one or more reports so as to identify, on the given computer, a given ID of a given process responsible for the alert. Finally, a protective action is initiated for the given process.

### FIELD OF THE INVENTION

The present invention relates generally to computer security, and particularly identifying a process executing on a host computer and responsible for malicious activity.

### BACKGROUND OF THE INVENTION

In many computers and network systems, multiple layers of security apparatus and software are deployed in order to detect and repel the ever-growing range of security threats. At the most basic level, computers use anti-virus software to prevent malicious software from running on the computer. At the network level, intrusion detection and prevention systems analyze and control network traffic to detect and prevent malware from spreading through the network.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method including collecting, during a time period from security agents executing on respective host computers, reports of communication events, each of the communication events including communication activity performed by a process having a respective process identifier (ID) and executing on one of the host computers, generating, from each of the collected reports, a set of features including characteristics of the communication activity and the respective process ID, training, by a processor, a model for identifying, based on the features of one or more of the events, the process ID of one of the processes performing the one or more of the events, receiving, from a network management device subsequent to the time period, an alert indicating malicious activity and referencing one or more reports of additional communication events performed by a given host computer, applying the model to the one or more reports of additional communication events so as to identify, on the given host computer, a given process ID of a given process responsible for the alert, and initiating a protective action with respect to at least the given process executing on the given host computer.

In one embodiment, the network management device includes a firewall.

In another embodiment, generating a given feature includes extracting a given feature from a given collected report.

In an additional embodiment, generating a given feature includes normalizing the extracted given feature.

In a further embodiment, generating a given feature includes computing the given feature based on one or more of the extracted features.

In a first feature embodiment, a given feature includes a domain.

In a second feature embodiment, a given feature includes an Internet Protocol (IP) address.

In some embodiments, a given feature indicates whether or not the IP address includes an Autonomous System Number (ASN).

In a third feature embodiment, a given feature includes a JA3 fingerprint.

In a fourth feature embodiment, a given feature includes a JA3S fingerprint.

In a fifth feature embodiment, a given feature includes a Server Name Indication (SNI) hostname.

In a sixth feature embodiment, a given feature includes the given process identifier.

In a seventh feature embodiment, a given feature includes a logical port number.

In an eighth feature embodiment, a given feature includes the process ID.

In a ninth feature embodiment, a given feature includes one or more network protocols used in the communication activity.

The method according to claim 1, wherein applying the model includes generating additional features from the one or more additional communication events, and applying the model to the additional features.

In another embodiment, the host computers include first host computers, and the given host computer includes an additional host computer different from any of the first host computers.

In an additional embodiment, initiating the protective with respect to a given process includes isolating the given process.

In a further embodiment, initiating the protective with respect to a given process includes presenting, on a display, details of the given process.

In a supplemental embodiment, receiving the alert includes receiving a given report for a specific communication event.

There is also provided, in accordance with an embodiment of the present invention, an apparatus including a memory configured to store a model, and a processor configured to collect, during a time period from security agents executing on respective host computers, reports of communication events, each of the communication events including communication activity performed by a process having a respective process ID and executing on one of the host computers, to generate, from each of the collected reports, a set of features including characteristics of the communication activity and the respective process ID, to train the model to identify, based on the features of one or more of the events, the process ID of one of the processes performing the one or more of the events, to receive, from a network management device subsequent to the time period, an alert indicating malicious activity and referencing one or more reports of additional communication events performed by a given host computer, to apply the model to the one or more reports of additional communication events so as to identify, on the given host computer, a given process ID of a given process responsible for the alert, and to initiate a protective action with respect to at least the given process executing on the given host computer.

There is additionally provided, in accordance with an embodiment of the present invention, a computer software product for protecting a computing device, which includes a processor and a memory and is coupled to a storage device storing a set of one or more software product including a non-transitory computer-readable medium, in which program instructions are stored, which instructions, when read by a computer, cause the computer to collect, during a time period from security agents executing on respective host computers, reports of communication events, each of the communication events including communication activity performed by a process having a respective process ID and executing on one of the host computers, to generate, from each of the collected reports, a set of features including characteristics of the communication activity and the respective process ID, to train a model for identifying, based on the features of one or more of the events, the process ID of one of the processes performing the one or more of the events, to receive, from a network management device subsequent to the time period, an alert indicating malicious activity and referencing one or more reports of additional communication events performed by a given host computer, to apply the model to the one or more reports of additional communication events so as to identify, on the given host computer, a given process ID of a given process responsible for the alert, and to initiate a protective action with respect to at least the given process executing on the given host computer.

### BRIEF DESCRIPTION OF THE DRAWINGS

The disclosure is herein described, by way of example only, with reference to the accompanying drawings, wherein:

FIG. 1 is a block diagram showing an example of a computing facility comprising a security server that can execute a machine learning model that is configured to enrich alerts received from a network management device, in accordance with an embodiment of the present invention;

FIG. 2 is a block diagram that shows an example of a configuration of the security server, in accordance with an embodiment of the present invention; and

FIG. 3 is a flow diagram that schematically illustrates a method of enriching a detected alert and performing a protective action in response to the alert, in accordance with an embodiment of the present invention.

### DETAILED DESCRIPTION OF EMBODIMENTS

Different networks can deploy different types of security systems for detecting malicious activity (e.g., transmissions) on the network. A first type of security system can be installed on a network management device that manages data traffic between endpoints on the network, and a second type of security system can be installed on security agents executing on the endpoints themselves.

While the first type of security system typically requires less resources to manage than the second type of security system, it is typically limited to identifying endpoints generating malicious data traffic. On the other hand, while the second type of system is typically more costly and requires more management, it typically can identify any processes on any endpoint performing malicious activity.

Embodiments of the present invention provide methods and systems for a security server to implement a machine learning model that can enrich alerts received from a network management device (e.g., a firewall) with information gleaned from security agents. In embodiments described hereinbelow, the security server can enrich these alerts by identifying a given software process that is executing on a host computer and performing communication activity that triggered the alert.

As described hereinbelow, during a time period (e.g., a training period) reports of communication events are collected from security agents executing on respective host computers, each of the communication events comprising communication activity performed by a process having a respective process identifier (ID) and executing on one of the host computers. Respective sets of features comprising characteristics of the communication activity and the respective process ID are generated from the collected reports, and the generated features are used to train a model for identifying the process ID of one of the processes performing the one or more of the events based on the features of one or more of the events.

Subsequent to the time period (e.g., during production), an alert is received from a network management device, the alert indicating malicious activity and referencing one or more reports of additional communication events performed by a given host computer. Upon receiving the alert, the model is applied to the one or more reports of additional communication events so as to identify, on the given host computer, a given process ID of a given process responsible for the alert. Finally, a protective action is initiated with respect to at least the given process executing on the given host computer and having the given process ID.

### SYSTEM DESCRIPTION

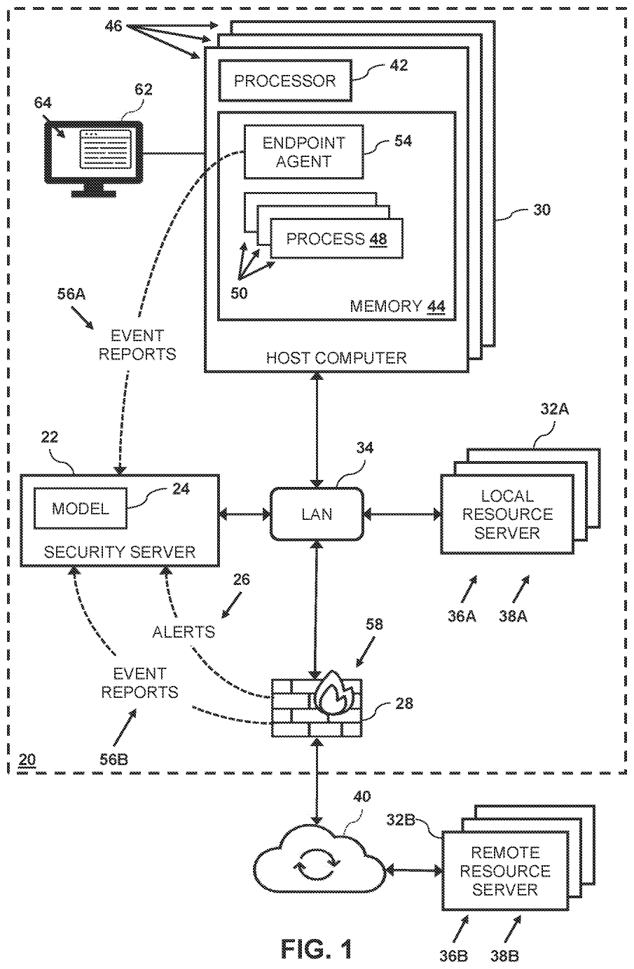

FIG. 1 is a block diagram that shows an example of a computing facility 20 comprising a security server 22 that executes an alert enrichment model 24 that is configured to enrich alerts 26 generated by a network management device such as a firewall 28, in accordance with an embodiment of the present invention.

In the configuration shown in FIG. 1, security server 22 can communicate with one or more host computers 30 and one or more resource servers 32 via a data network such as local area network (LAN) 34. In embodiments herein alerts 26 comprise reports of suspected malicious activity initiated by one or more host computers 30 and/or one or more resource servers 32.

In some embodiments, resource servers 32 comprise (i.e., can be referenced by or accessed via) respective domains 36, and the resource servers comprise respective Internet Protocol (IP) addresses 38. Resource servers can host, e.g., for computers 30, one or more web-based applications and/or provide network services such as database management systems.

LAN 34 is also coupled to a network management device such as firewall 28 that controls and monitors traffic between LAN 34 and a public network such as Internet 40, and can generate one or more alerts 26 upon detecting malicious traffic on LAN 34 and/or received from Internet 40. One example of firewall 28 is a PA-3250 NEXT GENERATION FIREWALL™ produced by PALO ALTO NETWORKS, INC. of 3000 Tannery Way, Santa Clara, CA 95054 USA.

In embodiments described herein, resource servers 32, domains 36 and IP addresses 38 can be differentiated by appending a letter to the identifying numeral, so that the resource servers comprise local resource servers 32A and remote resource servers 32B, the domains comprise domains 36A and 36B, and the IP addresses comprise addresses and 38A 38B. In the configuration shown in FIG. 1:
Resource servers 32A are coupled to LAN 34 and comprise respective domains 36A and IP addresses 38A.
Resource servers 32B are accessible to host computers 30 via Internet 40 and comprise respective domains 36B and IP addresses 38B.

Each given host computer 30 may comprise a host processor 42 and a host memory 44. Each host computer 30 comprises (i.e., can be referenced by) a unique host identifier (ID) 46 such as an Internet Protocol (IP) address or a Media Access Control (MAC) address.

In the configuration shown in FIG. 1, processor 42 executes, from memory 44, a set of processes 48 (i.e., memory 44 stores 48) having respective process identifiers (IDs) 50. In some embodiments, process IDs 50 comprise unique identifiers or process names for processes 48. Examples of process IDs 50 include, but are not limited to names of operating systems (e.g., WINDOWS™, produced by MICROSOFT CORPORATION, Redmond, Washington) and names of software applications (e.g., POWERSHELL™, CMD™, WORD™ OUTLOOK™ and EXCEL™, also produced by MICROSOFT CORPORATION).

Each given processor 42 may execute, from its respective memory 44, a respective instance of an endpoint security agent 54 (which may also be referred to herein as endpoint agent 54, security agent 54 or agent 54). One example of a given endpoint agent 54 is CORTEX EXTENDED DETECTION AND RESPONSE™ (XDR™), produced by PALO ALTO NETWORKS INC.

In embodiments described herein, endpoint agents 54 and firewall 28 can convey event that be reports 56 can differentiated by appending a letter to the identifying numeral, so that the event reports comprise event reports 56A generated and conveyed by endpoint security agents 54 and event reports 56B generated and conveyed by firewall 28. Event reports 56 provides information on communication activity on LAN 34 as follows:

Each given endpoint agent 54 executing on a given host computer 30 generates event reports 56A that provide information on communication activities performed by the given host computer. Since the endpoint agents execute on the host computers, each given event report 56A for a given communication activity can reference a given process 48 (e.g., by its respective process ID 50). Additionally, while endpoint agents 54 can generate event reports 56A that provide information of other types of activities (e.g., initiating or terminating a given process 48), embodiments of the present invention can be restricted to event reports 56A that provide information on communication activities.

Firewall 28 executes network device logic 58 that analyzes communication activities comprising data traffic to/from host computers 30 and resource servers 32A, and generates event reports 56B in response to the communication activities. For example, a given event report 56 (i.e., either 56A or 56B) may comprise a given host computer 30 transmitting a specific number of bytes to a given remote server 32B.

In embodiments of the present invention, event reports 56 typically reference communication activity typically comprise communicating between host computers 30 (or any computing devices behind firewall 28 and remote resource servers 32B (or any computing devices outside the firewall). Therefore, a given event report 56 may reference a given host computer 30 transmitting data to a given remote resource server 32B or a given host computer 30 receiving data from a given remote resource server 32B.

While the configuration in FIG. 1 shows firewall 28 executing network device logic 58, configurations where the network device logic executes on any other device such as given host computer 30 or a given server 32A are considered to be within the spirit and scope of the present invention.

In some embodiments, a given host computer 30 may comprise a display 62, and processor 42 can present, on the display, a rendering 64 comprising the alert context information, as described hereinbelow.

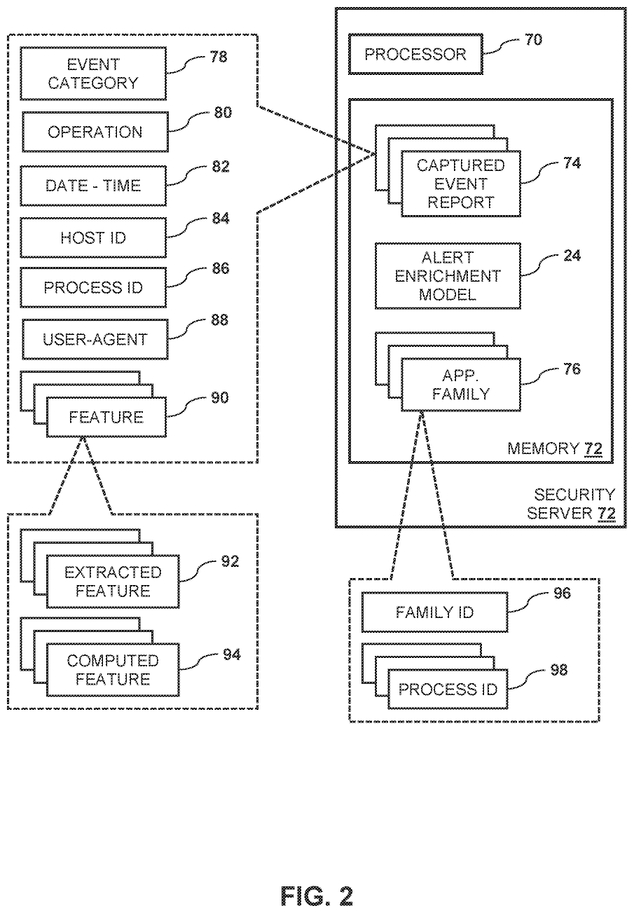

FIG. 2 is a block diagram that shows hardware and software components of security server 22, in accordance with an embodiment of the present invention. In the configuration shown in FIG. 2, security server 22 comprises a security processor 70 and a security memory 72 that comprises alert enrichment model 24, a set of captured event reports 74, and a set of application families 76.

Each given captured event report 74 corresponds to a given event report 56, and can include activity (i.e., event) information such as:
An event category 78 that can be used to classify the activity performed by a given process 48 executing on a given host computer 30. Examples of event categories 78 include but are not limited to communication activity (e.g., transmitting data), file activity (e.g., accessing a file) and process activity (e.g., initiating execution of a given process 48).
An operation 80 indicating details of the activity. Examples of operations 80 include a file upload or transmitting a Hypertext Transfer Protocol (HTTP) request.
A date and time 82 of the activity.
A host ID 84 comprising (i.e., storing) a given host ID 46 referencing a given host computer 30 that performed the action.
A process ID 86 referencing a given process 48 that performed the action while executing on the given host computer. In embodiments described herein, processor 70 can extract process ID 86 (typically only) from event reports 56A.
A user-agent 88 that comprises information such as an operating system ID (e.g., WINDOWS™) executing on a given host computer 30 that generated the given captured event report and a given process ID 86 of a software application (not shown) that is executing on the given host computer and performed the operation in the given captured event report. For example, the given process ID can reference a web browser such as CHROME™ (produced by ALPHABET INC., 1600 Amphitheatre Parkway, Mountain View, CA 94043, USA).
A set of features 90 comprising characteristics of the action. Features 90 comprise extracted features 92 that processor 70 can extract from the given event reports, and computed features 94 that comprise statistical values that the server processor can compute based on the extracted features.

Examples of extracted features 92 that processor 70 can extract from a given event report 56 for a given communication session managed by a given process 48 include, but are not limited to:
A given domain 36 accessed in the given communication session. In some embodiments, processor 70 can normalize the given domain by identifying a root domain for the given domain, and use the normalized root domain as a given feature 90.
A given IP address 38 accessed in the given communication session.
An indication of whether or not the given IP address comprises an Autonomous System Number (ASN).
A JA3 fingerprint comprising a fingerprint of Secure Socket Layer (SSL)/Transport Layer Security (TLS) negotiation between a given host computer 30 (i.e., the client) and a given server 32. In some embodiments, processor 70 can normalize the given JA3 fingerprint, and use the normalized JA3 fingerprint as a given feature 90.
A JA3S fingerprint comprising a server-side fingerprint of Secure Socket Layer (SSL)/Transport Layer Security (TLS) negotiation between a given host computer 30 (i.e., the client) and a given server 32 during a response from the given server. In some embodiments, processor 70 can normalize the given JA3S fingerprint, and use the normalized JA3S fingerprint as a given feature 90.
A Server Name Indication (SNI) indicating a hostname (i.e., referencing a given host computer 30 or a given server) to which the given communication session is attempting to connect at the start of the handshaking process.
A given process ID 86 for a software application (e.g., WORD or EXCEL) referenced by the process ID of the given process that performed the given communication session. In one embodiment, process ID 86 is provided by a given event report 56A. In another embodiment, process ID 86 can be computed (i.e. “predicted”) by model 24 using embodiments described herein.
A sequence of one or more network protocols used in the given communication session. In some embodiments each of the network protocols may have a specific purpose (i.e., for a specific service), such as web browsing. Examples of these network protocols are described hereinbelow.
A logical communication port number accessed in the given communication session.
A duration of the given communication session.
An amount of data transmitted and/or received in the given communication session.

Examples of computed features 94 include, but are not limited to:
A count of how many endpoint agents reported a given communication session accessing a given domain 36.
A count of how many endpoint agents reported a given communication session accessing a given IP address 38.
A count of how many endpoint agents reported a given communication session comprising a given JA3 fingerprint.

In some embodiments, a given process ID 86 may referencing a software application belong a single family of applications (e.g., OFFICE™ produced by MICROSOFT CORPORATION), and therefore exhibit similar characteristics when executing on a given processor 42. In these embodiments, each application family 76 may comprise a family ID 98 and a plurality of process IDs 98 referencing the software applications in the family. For example, a given process ID 98 may be shared among OFFICE™ applications whose respective process IDs 98 reference WORD™, OUTLOOK™ and EXCEL™. In one family embodiment, processor 70 can identify the applications referenced by process IDs 98 by detecting a shared common path “\Program Files \Microsoft Office” for the identified applications. In another family embodiment, processor 70 can identify the applications referenced by process IDs 98 by detecting any identical domains or IP addresses accessed by the applications.

Processors 42 and 70 comprise general-purpose central processing units (CPU) or special-purpose embedded processors, which are programmed in software or firmware to carry out the functions described herein. This software may be downloaded to security server 22 and host computers 30 in electronic form, over a network, for example. Additionally or alternatively, the software may be stored on tangible, non-transitory computer-readable media, such as optical, magnetic, or electronic memory media. Further additionally or alternatively, at least some of the functions of processors 42 and 70 may be carried out by hard-wired or programmable digital logic circuits.

Examples of memories 44 and 72 include dynamic random-access memories, non-volatile random-access memories, hard disk drives and solid-state disk drives.

In some embodiments, tasks described herein performed by processors 42, 70 and network device logic 58 may be split among multiple physical and/or virtual computing devices. In other embodiments, these tasks may be performed in a managed cloud service.

### Network Management Device Alert Enrichment

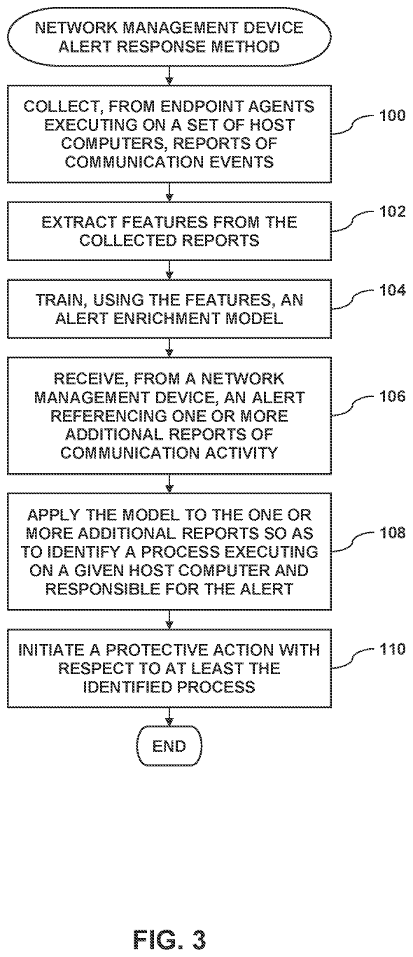

FIG. 3 is a flow diagram that schematically illustrates a method of selecting and performing a protective action in response to detecting a given alert 26, in accordance with an9 embodiment of the present invention.

In step 100, processor 70 collects, during a time period (i.e., a training period), event reports 56B from endpoint agents 54. As described supra, each report 56B references a communication event comprising communication activity performed by a given process 48 having one of process IDs 50.

In step 102, processor 70 generates features 90 by extracting features 92 from the collected events and the collected process ID, and computing features 94 based on extracted features 92. The following are examples of information that can be stored to two different captured event reports (i.e., for two different communication events.

In the first example (i.e., for a first given communication session:
Family ID 96: system.
A first given feature 92 referencing the network protocols in the communication session: ip, tcp, ssh
Process ID 86: ssh
A second given feature 92 referencing the logical communication port number accessed in the communication session: 53.
The operating system ID for user-agent 88: WINDOWS™
Domain 36: notsafe.com
IP address 38: 1.2.3.4
Operation 80: Uncommon network tunnel creation
User-agent 88: Mozilla/5.0 (Windows NT 10.0; Win64; x64) AppleWebKit/537.36 (KHTML, like Gecko) Evernote/10.51.7 Chrome/102.0.5005.167 Electron/19.1.8 Safari/537.36.
A third given feature 92 referencing the SNI in the communication session: notsafe.com.
A third given feature 92 referencing the JA3 fingerprint in the communication session: b32309a26951912be7dba376398abc3b.
A fourth given feature 92 referencing the JA3S fingerprint in the communication session: 6da3d3d0a98c7d4d4822c1f2429a720b

In the second example (i.e., for a second given communication session:
Family ID 96: browser.
A first given feature 92 referencing the network protocols in the communication session: ip, tcp, boxnet-base.
Process ID 86: CHROME™
A second given feature 92 referencing the logical communication port number accessed in the communication session: 443.
The operating system ID for user-agent 88: WINDOWS™
Domain 36: app.box.com
IP address 38: 5.6.7.8.
Operation 80: A user accessed an uncommon external file-sharing service
User-agent 88: Microsoft-CryptoAPI/10.0.
A third given feature 92 referencing the SNI in the communication session: app.box.com.
A third given feature 92 referencing the JA3 the communication session: fingerprint in 9c29c3d400525d0f8afd693d67295de7
A fourth given feature 92 referencing the JA3S fingerprint in the communication session: 16c0b3e6a7b8173c16d944cfeaeee9cf

In step 104, processor 70 trains model 24 with process IDs 86 and features 90. In embodiments herein, model 24 comprises a machine learning model that can identify, based on features 90 generated for a given event report 56, a given process ID 50 for a given process 48 that performed a given communication event corresponding to the given event report.

In some embodiments, processor 70 can also use other information stored in the captured event reports (e.g., event category 78, operation 80, date and time 82, host ID 84, user-agent 88) to train model 24. In these embodiments, all the information stored in the captured event reports may be referred to collectively as features 90.

In step 106, at a time subsequent to the time period (e.g., during production subsequent to the training period), processor 70 receives, from network device logic 58, a new alert 26 indicating malicious activity performed by a given host computer 30 and referencing one or more event reports 56B. In one embodiment, a given endpoint agent 54 can analyze the communication events in communication event reports 56A that were generated by the given endpoint agent, detect suspected malicious activity in on or more of the communication events (i.e., a single communication event or a sequence of multiple communication events), and generate an alert for the detected suspicious malicious activity. Likewise, firewall 28 can analyze the communication events in communication event reports 56A that were generated by the firewall, detect suspected malicious activity in on or more of the communication events, and generate an alert for the detected suspicious malicious activity.

Upon receiving the new alert, processor 70 collects the referenced event reports 56B (that reference respective communication events comprising communication activity performed by the given host computer), and generates additional features 90 from the referenced one or more event reports 56B.

In step 108, processor 70 applies model 24 to the one or more referenced event reports (including the additional features generated from the one or more referenced event reports) so as to identify, on the given host computer, the process ID(s) of one or more processes 48 on the given host computer that performed the communication activity referenced by the one or more event reports 56B, and are therefore responsible for the received alert. Using model 24 to identify the one or more processes is described hereinbelow.

Finally, in step 110, processor 70 initiates a protective action with respect to at least the identified one or more processes, and the method ends. In one protective action embodiment, processor 70 can initiate the protective action by performing an isolation action (e.g., terminating, quarantining or removing) on the identified one or more processes or on the host computer executing the identified one or more processes. To identify the given process, model 24 can identify a given process ID 50, and processor 70 can convey, to the given host computer a request to perform the protective action on any processes 48 executing on the given host computer and whose respective process ID(s) 50 matches the given process ID 50 (i.e., the output of model 24).

In another protective action embodiment, processor 70 can initiate the protective action by presenting, to a security operations center (SOC) analyst (not shown), details (e.g., the process ID) of the identified one or more processes in rendering 64 on display 62. In this embodiment, rendering 64 provides the SOC analyst with context for the received alert, thereby enabling the SOC analyst to formulate an effective response.

While the embodiments describe supra describe identifying a given process 48 on a given host computer 30, using these embodiments to identify processes 48 on other computing devices is considered to be with the spirit and scope of the present invention. In one example, processor 70 can use embodiments described herein to identify a given process 48 executing on a given server 32A. In another example, model 24 can be deployed on a different security server 22 that protects, using embodiments described hereinabove, computing devices (e.g., host computers and/or server computers) in a different computing facility.

In some embodiments, identifying the one or more processes (i.e., in the description referencing step 108 hereinabove) may comprise identifying a chain of processes 48 ending with a given process 48 responsible for the alert. For example, the chain may comprise a first process 48 referencing EXPLORER.EXE that spawns a second process 48 referencing FIREFOX.EXE, that spawns a third process 48 referencing FIREFOXUPDATER.EXE that performed the communication activity that triggered a given alert 26. In these embodiments, processor 70 can perform a protective action on one or more of the processes in the chain (e.g., the third process, the second and third processes, or the first, second and third processes).

Additionally, in these embodiments, while the event category of the process that triggered a given alert 26 typically indicates communication activity, the event category of a given parent processes in the chain (e.g., EXPLORER. EXE and FIREFOX.EXE in the example described supra) may not indicate communication activity.

In additional embodiments, processor 70 can compare a given identified process ID 50 (i.e., in step 108) to process IDs 98 in application families 76. In these embodiments, processor 70 can compare the process ID identified by model 24 to process IDs 98 and detect a match between the process ID identified by the model and a given process ID 9 in a given application family 76. Processor 70 can then perform any of the protective actions described supra on any processes 48 executing on the given host computer whose respective process ID 86 matches any process ID 98 in the given application family.

Furthermore, while embodiments described hereinabove describe enriching alerts 26, using these embodiments to enrich event reports 56 is considered to be within the spirit and scope of the present invention.

In a further embodiment, processor 42 can use embodiments described supra (i.e., in the description referencing steps 106-108) to enrich specific event reports 56B. In other words, processor 42 can perform in response to a specific event report 56B even if the processor does not receive a given alert 26 referencing the specific event report. In these embodiments, upon receiving the specific report, processor 42 can:
Generates additional features 90 from the specific event reports 56B.
Apply model 70 to the specific event report and the generated features so as to identify, one or more process IDs 50 of one or more processes 48 on a given host computer 30 that performed the communication activity referenced by the specific event report, and is/are therefore responsible for communication activity in the specific event report.
Initiates a protective action with respect to at least the identified one or more processes.

For example, processor 42 can use these further embodiments to flag any communication activity to/from a specific domain and/or IP address.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
collecting, during a time period from security agents executing on respective host computers, reports of communication events, each of the communication events comprising communication activity performed by a process having a respective process identifier (ID) and executing on one of the host computers;
generating, from each of the collected reports, a set of features comprising characteristics of the communication activity and the respective process ID;
training, by a processor, a model for identifying, based on the features of one or more of the events, the process ID of one of the processes performing the one or more of the events;
receiving, from a network management device subsequent to the time period, an alert indicating malicious activity and referencing one or more reports of additional communication events performed by a given host computer;
applying the model to the one or more reports of additional communication events so as to identify, on the given host computer, a given process ID of a given process responsible for the alert; and
initiating a protective action with respect to at least the given process executing on the given host computer.

2. The method according to claim 1, wherein the network management device comprises a firewall.

3. The method according to claim 1, wherein generating a given feature comprises extracting a given feature from a given collected report.

4. The method according to claim 3, wherein generating a given feature comprises normalizing the extracted given feature.

5. The method according to claim 3, wherein generating a given feature comprises computing the given feature based on one or more of the extracted features.

6. The method according to claim 3, wherein a given feature comprises a domain.

7. The method according to claim 3, wherein a given feature comprises an Internet Protocol (IP) address.

8. The method according to claim 7, wherein a given feature indicates whether or not the IP address comprises an Autonomous System Number (ASN).

9. The method according to claim 3, wherein a given feature comprises a JA3 fingerprint.

10. The method according to claim 3, wherein a given feature comprises a JA3S fingerprint.

11. The method according to claim 3, wherein a given feature comprises a Server Name Indication (SNI) hostname.

12. The method according to claim 3, wherein a given feature comprises the given process identifier.

13. The method according to claim 3, wherein a given feature comprises a logical port number.

14. The method according to claim 3, wherein a given feature comprises the process ID.

15. The method according to claim 3, wherein a given feature comprises one or more network protocols used in the communication activity.

16. The method according to claim 1, wherein applying the model comprises generating additional features from the one or more additional communication events, and applying the model to the additional features.

17. The method according to claim 1, wherein the host computers comprise first host computers, and wherein the given host computer comprises an additional host computer different from any of the first host computers.

18. The method according to claim 1, wherein initiating the protective with respect to a given process comprises isolating the given process.

19. The method according to claim 1, wherein initiating the protective with respect to a given process comprises presenting, on a display, details of the given process.

20. The method according to claim 1, wherein receiving the alert comprises receiving a given report for a specific communication event.

21. An apparatus, comprising:
a memory configured to store a model; and
a processor configured:
to collect, during a time period from security agents executing on respective host computers, reports of communication events, each of the communication events comprising communication activity performed by a process having a respective process ID and executing on one of the host computers,
to generate, from each of the collected reports, a set of features comprising characteristics of the communication activity and the respective process ID,
to train the model to identify, based on the features of one or more of the events, the process ID of one of the processes performing the one or more of the events,
to receive, from a network management device subsequent to the time period, an alert indicating malicious activity and referencing one or more reports of additional communication events performed by a given host computer,
to apply the model to the one or more reports of additional communication events so as to identify, on the given host computer, a given process ID of a given process responsible for the alert, and
to initiate a protective action with respect to at least the given process executing on the given host computer.

22. A computer software product for protecting a computing device, which includes a processor and a memory and is coupled to a storage device storing a set of one or more files, the computer software product comprising a non-transitory computer-readable medium, in which program instructions are stored, which instructions, when read by a computer, cause the computer:
to collect, during a time period from security agents executing on respective host computers, reports of communication events, each of the communication events comprising communication activity performed by a process having a respective process ID and executing on one of the host computers;
to generate, from each of the collected reports, a set of features comprising characteristics of the communication activity and the respective process ID;
to train a model for identifying, based on the features of one or more of the events, the process ID of one of the processes performing the one or more of the events;
to receive, from a network management device subsequent to the time period, an alert indicating malicious activity and referencing one or more reports of additional communication events performed by a given host computer;
to apply the model to the one or more reports of additional communication events so as to identify, on the given host computer, a given process ID of a given process responsible for the alert; and
to initiate a protective action with respect to at least the given process executing on the given host computer.
